(19) United States
(12) Patent Application Publication
(10) Pub. No.: US 2026/0061520 A1
(43) Pub. Date: Mar. 5, 2026

(54) VEHICLE WITH WELDED BUS BAR CONNECTIONS

(71) Applicant: FORD GLOBAL TECHNOLOGIES, LLC, Dearborn, MI (US)

(72) Inventors: Paul Bojanowski, Macomb Township, MI (US); Michael Orr, Ferndale, MI (US); Ife Siffre, Detroit, MI (US); Matthew Andriese, West Bloomfield, MI (US)

(21) Appl. No.: 18/817,776

(22) Filed: Aug. 28, 2024

(51) Int. Cl. B23K 26/352; B23K 26/0622; B23K 26/082; B23K 26/21; B23K 101/00; B23K 101/36; B23K 103/12

(52) U.S. Cl. CPC B23K 26/3576; B23K 26/0622; B23K 26/082; B23K 26/21; B23K 2101/006; B23K 2101/36; B23K 2103/12

(57) ABSTRACT

In a high voltage vehicle electronics system, laser welding may be used to connect components mechanically and electrically to bus bars. To overcome issues associated with the high reflectivity of materials commonly used for these applications, a laser-applied surface treatment is used on the components. The surface treatment alters several properties, including reflectivity, of the surface, improving the quality of the resulting weld.

### TECHNICAL FIELD

This disclosure pertains to laser welding. More particularly, this disclosure pertains to laser welding of a high voltage electrical system for an electric vehicle.

### BACKGROUND

Laser welding works on the principle of using a focused beam of light, typically generated by a laser source, to heat and melt the materials being joined. The laser beam is directed precisely onto the joint area, where it rapidly heats the material to its melting point, creating a weld pool. Once the laser energy is removed from a given region, the melted material solidifies, forming a strong bond between the parts.

Continuous wave laser welding involves the continuous emission of laser energy onto the workpiece without interruption. The focus region is continuously moved along the material. Pulsed laser welding involves emitting laser energy in short pulses, with each pulse lasting for a fraction of a second. The focus region is typically constant during a pulse and is moved to a different location between pulses.

Laser welding is a highly versatile joining process, but it presents unique challenges when working with materials like copper and aluminum due to their distinct properties. Copper and aluminum have relatively high thermal conductivities. This high thermal conductivity makes it challenging to achieve sufficient heating at the weld joint. Copper and aluminum are also highly reflective to infrared radiation, including the wavelength commonly used in many laser welding processes. This reflectivity can result in poor absorption of laser energy, leading to insufficient heating.

### SUMMARY

A method of laser welding a first sheet metal component to a second sheet metal component includes treating a first surface of the first component, holding the components together, and applying laser energy. The first surface of the first component is treated by using a pulsed laser to focus energy on an array of spots within a surface treatment region thereby changing a reflectivity of the first surface in the surface treatment region. The two components are held together such that a second surface of the first component is against a first surface of the second component. Laser energy is applied to the first surface of the first component within the surface treatment region to create a melt pool extending through the first component into the second component. A focus point of the laser energy may be moved along a path within the surface treatment region. The first component may be made of copper.

An electrical system includes first and second components. The first component has a laser-applied surface treatment region. The second component is adjacent to a surface of the first component opposite the surface treatment region and is laser welded to the first component by a laser weld within the laser-applied surface treatment region. The first component may be copper. The laser-applied surface treatment region may have: a root mean square height, Sq, exceeding 1.00 μm, a maximum pit height from mean, Sv, less than −3.00 μm, a maximum peak height from mean, Sp, exceeding 4.00 μm, a root mean square gradient, Sdq/10, exceeding 25.00 μm/mm, a core height, Sk, exceeding 3.00 μm, a reduced peak height, Spk, exceeding 1.00 μm, and/or a reflectivity less than 60%.

An electrified vehicle includes a bus bar and an electrical component having a metal tab laser welded to the bus bar. A surface of either the bus bar or the tab includes a laser-applied surface treatment region. The laser weld joining the bus bar to the metal tab extends from the laser-applied surface treatment region into the other of the bus bar and the metal tab. The bus bar and the metal tab may be copper. The electrical component may be a battery cell, a power electronics module configured to convert Direct Current (DC) to Alternating Current (AC), or a power conversion module configured to coordinate delivery of electrical power from a charge port to a battery. The laser-applied surface treatment region may have: a root mean square height, Sq, exceeding 1.00 μm, root mean square gradient, Sdq/10, exceeding 25.00 μm/mm, and/or a reflectivity less than 60%.

### BRIEF DESCRIPTION OF THE DRAWINGS

FIG. 1 illustrates a block diagram of an electric vehicle.

FIG. 2 illustrates a structure of a high voltage electrical system suitable for use in an electric vehicle such as the vehicle of FIG. 1.

FIG. 3 illustrates a structure of a battery suitable for use in the high voltage electrical system of FIG. 2.

FIG. 4 is a top view of a first laser weld connection between a tab and a bus bar suitable for use in the electrical system of FIG. 2 or the battery of FIG. 3.

FIG. 5 is a cross sectional view of the first laser weld connection of FIG. 4.

FIG. 6 is a top view of a component to be welded having a laser-applied surface treatment.

FIG. 7 is a cross sectional view of the component of FIG. 6.

FIG. 8 is a top view of a second laser weld connection between a tab and a bus bar suitable for use in the electrical system of FIG. 2 or the battery of FIG. 3.

FIG. 9 is a cross sectional view of the second laser weld connection of FIG. 8.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

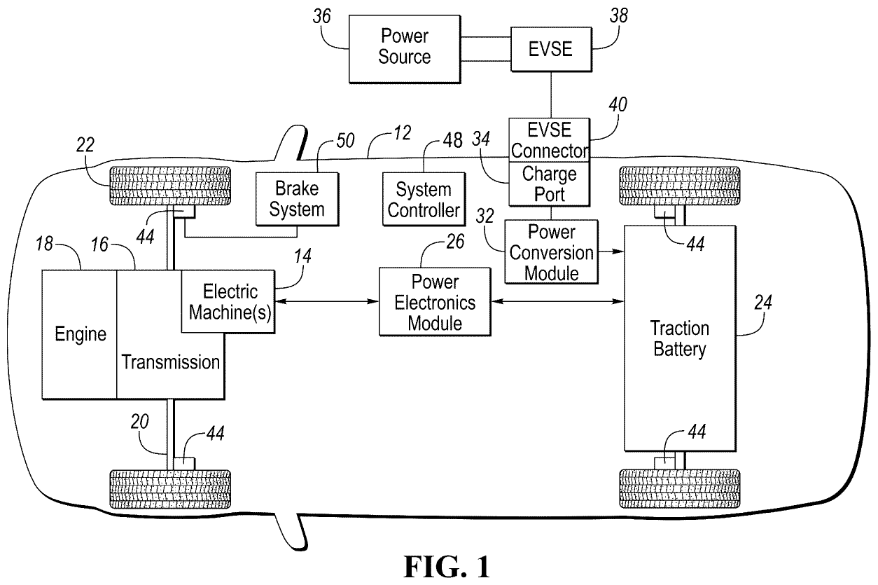

Referring now to FIG. 1, a block diagram of an exemplary electric vehicle (“EV”) 12 is shown. In this example, EV 12 is a plug-in hybrid electric vehicle (PHEV). EV 12 includes one or more electric machines 14 (“e-machines”) mechanically connected to a transmission 16. Electric machine 14 is capable of operating as a motor and as a generator. Transmission 16 is mechanically connected to an engine 18 and to a drive shaft 20 mechanically connected to wheels 22. Electric machine 14 can provide propulsion and slowing capability while engine 18 is turned on or off. Electric machine 14 may reduce vehicle emissions by allowing engine 18 to operate at more efficient speeds and allowing EV 12 to be operated in electric mode with engine 18 off under certain conditions.

A traction battery 24 (“battery) stores energy that can be used by electric machine 14 for propelling EV 12. Battery 24 typically provides a high-voltage (HV) direct current (DC) output. Battery 24 is electrically connected to a power electronics module 26. Power electronics module 26 is electrically connected to electric machine 14 and provides the ability to bi-directionally transfer energy between battery 24 and the electric machine. For example, battery 24 may provide a DC voltage while electric machine 14 may require a three-phase alternating current (AC) voltage to function. Power electronics module 26 may convert the DC voltage to a three-phase AC voltage to operate electric machine 14. In a regenerative mode, power electronics module 26 may convert three-phase AC voltage from electric machine 14 acting as a generator to DC voltage compatible with battery 24.

Battery 24 is rechargeable by an external power source 36 (e.g., the grid). Electric vehicle supply equipment (EVSE) 38 is connected to external power source 36. EVSE 38 provides circuitry and controls to control and manage the transfer of energy between external power source 36 and EV 12. External power source 36 may provide DC or AC electric power to EVSE 38. EVSE 38 may have a charge connector 40 for plugging into a charge port 34 of EV 12. Charge port 34 may be any type of port configured to transfer power from EVSE 38 to EV 12. A power conversion module 32 of EV 12 may condition power supplied from EVSE 38 to provide the proper voltage and current levels to battery 24. Power conversion module 32 may interface with EVSE 38 to coordinate the delivery of power to battery 24. Alternatively, various components described as being electrically connected may transfer power using a wireless inductive coupling.

The various components discussed may have one or more associated controllers to control and monitor the operation of the components. The controllers can be microprocessor-based devices. The controllers may communicate via a serial bus (e.g., Controller Area Network (CAN)) or via discrete conductors. For example, a system controller 48 (i.e., a vehicle controller) is present to coordinate the operation of the various components.

As described, EV 12 is in this example is a PHEV having engine 18 and battery 24. In other embodiments, EV 12 is a battery electric vehicle (BEV). In a BEV configuration, EV 12 does not include an engine.

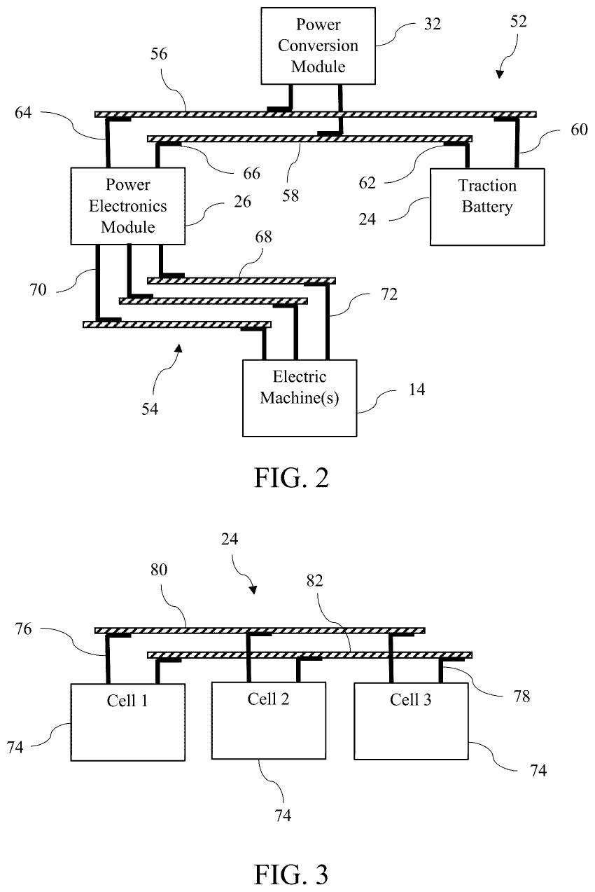

FIG. 2 illustrates the high voltage electrical system of EV 12, which connects the electric motor 14, the power electronics module 26, the battery 24, and the power conversion module 32 (if present). The high voltage electrical system includes a high voltage DC bus 52 and a high voltage AC bus 54.

The high voltage DC bus 52 may include a positive bus bar 56 and a negative bus bar 58. The bus bars may be copper, aluminum, or other electrically conductive material. The traction battery 24 includes a positive terminal 60 electrically connected to the positive bus bar 56 and a negative terminal 62 electrically connected to the negative bus bar 58. Similarly, the power electronics module includes a positive DC terminal 64 electrically connected to the positive bus bar 56 and a negative DC terminal 66 electrically connected to the negative bus bar 58. If present, the power conversion module 32 includes a positive terminal electrically connected to the positive bus bar 56 and a negative terminal electrically connected to the negative bus bar 58. The terminals may be copper, aluminum, or other electrically conductive material which may be the same material as the corresponding bus bar or may be a different material. The electrical connections may be formed by welding, such as laser welding.

The high voltage AC bus 54 may include three bus bars 68 each corresponding to one phase of a three-phase AC electrical signal. The power electronics module 26 and the electric motor 14 each include three AC terminals 70 and 72, each electrically connected to a corresponding one of the bus bars 68. The material options for the bus bars 68 and for the terminals 70 and 72 are the same as with the high voltage DC bus 52. The electrical connections may be formed by welding, such as laser welding.

FIG. 3 illustrates a structure suitable for the traction battery 24. The battery may include a set of battery cells 74. Each battery cell 74 may include a positive terminal 76 and a negative terminal 78. The terminals may be copper, aluminum, or other electrically conductive material. Each positive terminal may be electrically connected to positive bus bar 80 while each negative terminal may be electrically connected to negative bus bar 82. The bus bars may be copper, aluminum, or other electrically conductive material which may be the same material as the corresponding terminals or may be a different material. The electrical connections may be formed by welding, such as laser welding.

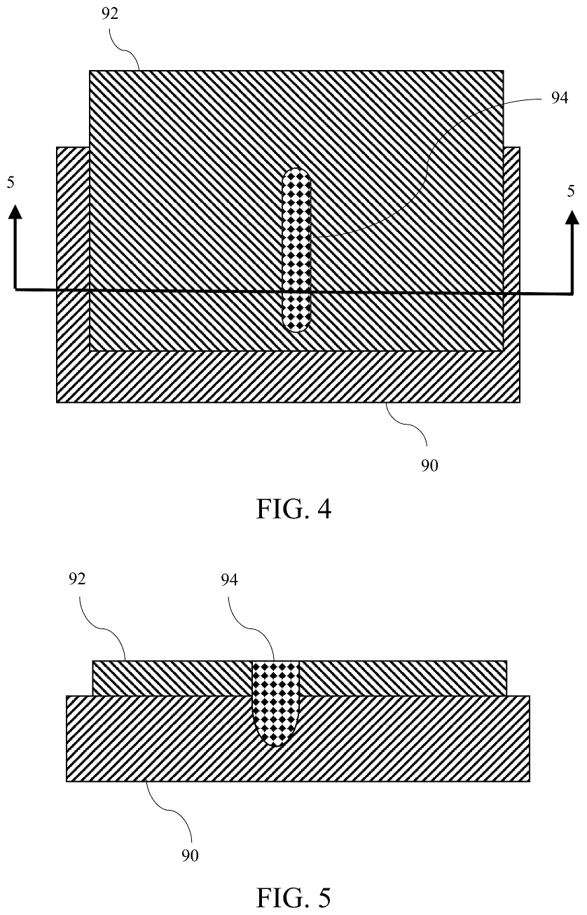

FIGS. 4 and 5 describe a particular connection between a tab 60, 62, 64, 66, 70, 76, or 78 and a bus bar 56, 58, 80, or 82 from the EV electrical system of FIG. 2 or the traction battery of FIG. 3. One of the tab and the bus bar is a bottom component 90 and the other one is a top component 92. The labels top and bottom in this context are used merely to distinguish the components from one another and do not imply relative spatial position. FIG. 4 is a top view of the connection whereas FIG. 5 is a cross sectional view. The top component is joined to the bottom component by a laser weld 94. This weld is formed by focusing laser energy on a spot on the top component, melting the material of the top component and the bottom component in the vicinity of the focus point. The focus point is then moved along the surface of the surface of the top component. As the melted material re-solidifies, it bonds to both the top component and the bottom component, mechanically and electrically connecting the top and bottom components to one another. The resolidified material has a distinct grain structure from either of the two joined components. At least the top component is made of copper, aluminum, or other metal with high reflectivity in the bandwidth used for laser welding. These materials may reflect as much as 90% of the incident laser energy, which increases the amount of energy that must be used and makes it more difficult to control the degree of melting.

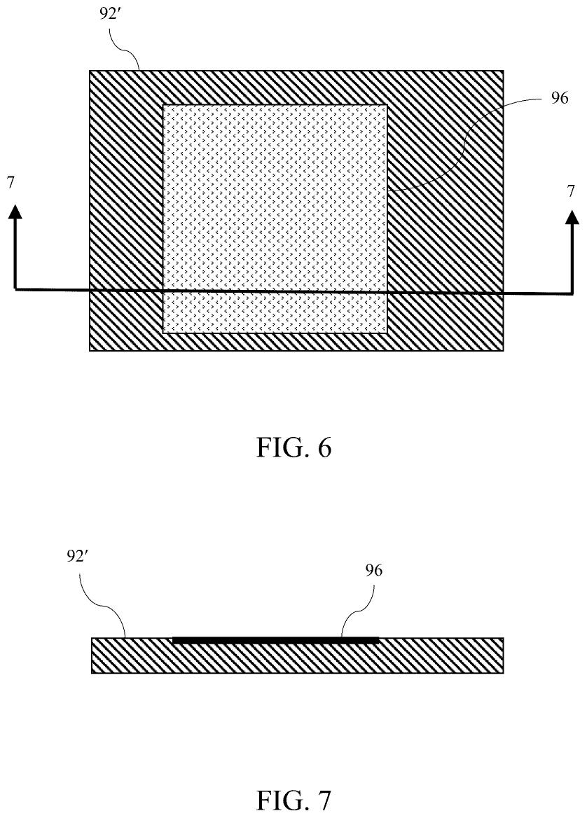

FIGS. 6 and 7 illustrate a top component 92′ with a laser-applied surface treatment 96. FIG. 6 is a top view of the connection whereas FIG. 7 is a cross sectional view. This surface treatment is applied using a pulsed laser. Energy is briefly focused on a spot on the surface. Then, the laser is turned off and the focus point is moved to another nearby point on the surface. This process is repeated until an array of spots have been treated. After the laser-applied surface treatment, there is a thin layer of on the top surface with an altered grain structure. The surface treatment changes the reflectivity such that 30-60% of incident laser energy is reflected as opposed to 90%.

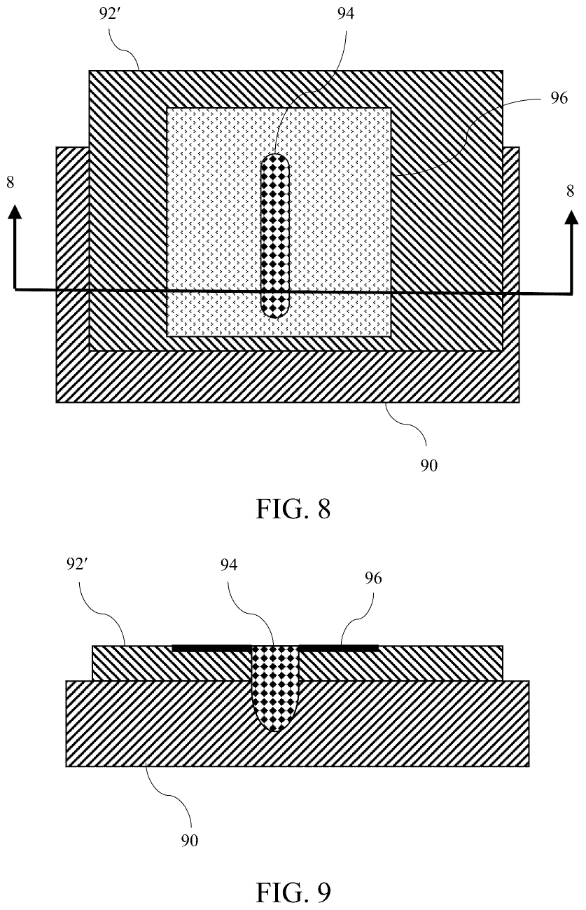

FIGS. 8 and 9 describe a particular connection between a top component 92′ and a bottom component 90. FIG. 8 is a top view of the connection whereas FIG. 9 is a cross sectional view. The top component 92′ is joined to the bottom component 90 by a laser weld 94 applied within the boundaries of the surface treatment 96. As with the connection of FIGS. 4 and 5, the laser weld is formed by focusing laser energy on a focus point to melt the material and gradually moving the focus point along the surface. However, since the reflectivity of the surface has been reduced to 30-60%, 40-70% of the incident energy is effective in melting the material as opposed to around 10%. Consequently, significantly lower energy is required improving the ability to control the quality of the weld.

Surfaces which are nominally flat may have significant small-scale features, called surface textures, which are related to the surface's properties. For example, polishing a surface or a product may transform the surface from feeling rough to feeling smooth even though the nominal dimensions of the product are unchanged, and the material is unchanged. These surface textures may be distributed in a well-defined pattern or may be randomly distributed. There are a number of ways to measure these small-scale features including mechanical profilers and optical measurement systems. There are a number of parameters that may be used to characterize various measurable attributes of a surface texture. These parameters include Sq, Sa, Sz, Sp, Sv, Ssk, Sku, Sal, Sdq, Sdr, Std, Str, Spd, Spc, Sk, Spk, Svk, Vvv, and PSD. As used in this document, these parameters shall have the meaning described in the international standard ISO 25178: Geometrical Product Specification—Surface texture: areal.

One surface parameter is the arithmetic mean height, Sa, which is approximately 0.076 μm for untreated copper. The inventors have discovered that a region with an effective laser-applied surface treatment is characterized by a Sa value between 1.00 μm and 2.00 μm.

Another surface parameter is the root mean square height, Sq, which is approximately 0.098 μm for untreated copper. The inventors have discovered that a region with an effective laser-applied surface treatment is characterized by an Sq value between 1.00 μm and 2.50 μm.

Another surface parameter is the maximum pit height from mean, Sv, which is approximately −0.564 μm for untreated copper. The inventors have discovered that a region with an effective laser-applied surface treatment is characterized by an Sv value between −8.00 μm and −3.00 μm.

Another surface parameter is the maximum height, Sz, which is approximately 1.012 μm for untreated copper. The inventors have discovered that a region with an effective laser-applied surface treatment is characterized by an Sz value between 8.00 μm and 20.00 μm.

Another surface parameter is the maximum peak height from mean, Sp, which is approximately 0.447 μm for untreated copper. The inventors have discovered that a region with an effective laser-applied surface treatment is characterized by an Sp value between 4.00 μm and 8.00 μm.

Another surface parameter is the skewness, Ssk, which is approximately −0.54 for untreated copper. The inventors have discovered that a region with an effective laser-applied surface treatment is characterized by an Ssk value between 0.00 and 0.25.

Another surface parameter is the Kurtois height, Sku, which is approximately 4.04 for untreated copper. The inventors have discovered that a region with an effective laser-applied surface treatment is characterized by an Sku value between 2.50 and 3.50.

Another surface parameter is the auto correlation length distance at which the surface height is changing most abruptly, Sal, which is approximately 15.005 μm for untreated copper. The inventors have discovered that a region with an effective laser-applied surface treatment is characterized by a Sal value between 10.00 μm and 14.50 μm.

Another surface parameter is the root mean square gradient, Sdq/10, which is approximately 1.673 μm/mm for untreated copper. The inventors have discovered that a region with an effective laser-applied surface treatment is characterized by an Sdq/10 value between 25.00 μm/mm and 35.00 μm/mm.

Another surface parameter is the developed interfacial ratio, Sdr, which is approximately 0 μm for untreated copper. The inventors have discovered that a region with an effective laser-applied surface treatment is characterized by an Sdr value between 0.03 μm and 0.06 μm.

Another surface parameter is the Dale void volume, Vvv, which is approximately 0.014 μm for untreated copper. The inventors have discovered that a region with an effective laser-applied surface treatment is characterized by an Vvv10 value between 0.120 μm and 0.250 μm.

Another surface parameter is the core height, Sk, which is approximately 0.228 μm for untreated copper. The inventors have discovered that a region with an effective laser-applied surface treatment is characterized by an Sk value between 3.000 μm and 6.000 μm.

Another surface parameter is the reduced peak height, Spk, which is approximately 0.078 μm for untreated copper. The inventors have discovered that a region with an effective laser-applied surface treatment is characterized by an Spk value between 1.000 μm and 2.500 μm.

Another surface parameter is the reduced value depth, Svk, also known as the reduced dale height, which is approximately 0.142 μm for untreated copper. The inventors have discovered that a region with an effective laser-applied surface treatment is characterized by an Svk value between 1.000 μm and 2.000 μm.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A method of laser welding a first sheet metal component to a second sheet metal component, the method comprising:
treating a first surface of the first component by using a pulsed laser to focus energy on an array of spots within a surface treatment region thereby changing a reflectivity of the first surface in the surface treatment region;
holding a second surface of the first component against a first surface of the second component; and
applying laser energy to the first surface of the first component within the surface treatment region to create a melt pool extending through the first component into the second component.

2. The method of claim 1 further comprising moving a focus point of the laser energy along a path within the surface treatment region.

3. The method of claim 1 wherein the first component is made of copper.

4. An electrical system comprising:
a first component having a laser-applied surface treatment region; and
a second component adjacent to a surface of the first component opposite the surface treatment region and laser welded to the first component by a laser weld within the laser-applied surface treatment region.

5. The electrical system of claim 4 wherein the first component is copper.

6. The electrical system of claim 4 wherein the laser-applied surface treatment region has a root mean square height, Sq, exceeding 1.00 μm.

7. The electrical system of claim 4 wherein the laser-applied surface treatment region has a maximum pit height from mean, Sv, less than −3.00 μm.

8. The electrical system of claim 4 wherein the laser-applied surface treatment region has a maximum peak height from mean, Sp, exceeding 4.00 μm.

9. The electrical system of claim 4 wherein the laser-applied surface treatment region has a root mean square gradient, Sdq/10, exceeding 25.00 μm/mm.

10. The electrical system of claim 4 wherein the laser-applied surface treatment region has a core height, Sk, exceeding 3.00 μm.

11. The electrical system of claim 4 wherein the laser-applied surface treatment region has a reduced peak height, Spk, exceeding 1.00 μm.

12. The electrical system of claim 4 wherein the laser-applied surface treatment region has a reflectivity less than 60%.

13. An electrified vehicle comprising:
a bus bar; and
an electrical component having a metal tab laser welded to the bus bar; wherein
a surface of one of the bus bar and the tab includes a laser-applied surface treatment region and the laser weld joining the bus bar to the metal tab extends from the laser-applied surface treatment region into another of the bus bar and the metal tab.

14. The electrified vehicle of claim 13 wherein the bus bar and the metal tab are copper.

15. The electrified vehicle of claim 13 wherein the electrical component is a battery cell.

16. The electrified vehicle of claim 13 wherein the electrical component is a power electronics module configured to convert Direct Current (DC) to Alternating Current (AC).

17. The electrified vehicle of claim 13 wherein the electrical component is a power conversion module configured to coordinate delivery of electrical power from a charge port to a battery.

18. The electrified vehicle of claim 13 wherein the laser-applied surface treatment region has a root mean square height, Sq, exceeding 1.00 μm.

19. The electrified vehicle of claim 13 wherein the laser-applied surface treatment region has a root mean square gradient, Sdq/10, exceeding 25.00 μm/mm.

20. The electrified vehicle of claim 13 wherein the laser-applied surface treatment region has a reflectivity less than 60%.
